(19) United States
(12) Patent Application Publication
(10) Pub. No.: US 2015/0290643 A1
(43) Pub. Date: Oct. 15, 2015

(54) Sample Metering Device

(71) Applicant: CARCLO TECHNICAL PLASTICS LIMITED, Ossett (GB)

(72) Inventors: Carolyn Jennifer RUDDELL, Wirral (GB); Jill Peta HILTON, Ossett (GB)

(21) Appl. No.: 14/428,261

(22) PCT Filed: Sep. 13, 2013
(86) PCT No.: PCT/GB2013/052404

§ 371 Date: Mar. 13, 2015

(30) Foreign Application Priority Data
Sep. 14, 2012 (GB) 1216454.7

(51) Int. Cl. B01L 3/00

(52) U.S. Cl. CPC B01L 3/502715; B01L 2200/027; B01L 2200/0689; B01L 2300/0877; B01L 2400/0406; B01L 2300/0867

(57) ABSTRACT

A sample metering device for a liquid sample comprises at least one capillary passage (1) with a first inlet (20) for receiving sample, and an outlet (5, 5′, 7, 7′); a side passage (3,3′) extending from the capillary passage part way along the length thereof and leading to the outlet (5, 5′, 7, 7′); and a second inlet (32) located between the first inlet (3,3′) and intersection with the side passage. A fluid application region (18) for receiving a liquid sample to be tested is provided for entry to the capillary passage (1) via the first inlet (20), and a second fluid application region (29) is provided for entry of fluid such as chase buffer to the capillary passage (1). The second inlet (32) prevents any excess sample in the well (18) entering the capillary passage (1) when chase buffer is applied.

### FIELD OF THE INVENTION

This invention relates to an improved sample metering device, for providing a predetermined quantity of a liquid sample.

### BACKGROUND TO THE INVENTION

There are many situations in which it is necessary to provide a predetermined quantity of a liquid sample, e.g. for testing purposes, and difficulties can arise in achieving this accurately and reliably in an easy manner not requiring complex equipment and/or skilled operators, particularly where very small quantities of liquid are involved such as in microfluidic devices. This applies e.g. with sample testing devices having one or more capillary passages for testing for the presence or amount of a component of interest in a liquid sample, commonly a body fluid such as blood (whole blood or plasma), urine, saliva, etc.

For a Point of Care assay system, it is desirable for an unskilled operator to add an unmeasured volume of sample to the device, and for the device to automatically abstract the required volume and sequester any excess in a secure manner to prevent contamination.

Many systems are based on “capturing” a defined volume from the start of flow and restricting the volume drawn into the assay capillary (e.g. using a wick region with a defined volume, such as many pregnancy tests). However, such approaches do have drawbacks. If the metering zone is fluidically connected to the rest of the device then unless care is exercised by the user, or some interruption is interposed in the pathway, an excess of fluid can be drawn through the metering zone and an incorrect volume obtained. With devices based on lumen-type capillaries it can be difficult to cause the fluid to leave the wick as the capillary forces in the wick are stronger than in the lumen.

Another approach has been to “capture” a defined volume from the fluid front, then use an overflow to discard excess sample from the rear of the sample flow. The defined volume is then transferred to the reaction area. US patent application No. 2011/0003286 uses such an approach. By using a combination of pressure and restrictions in the flow path, sample is caused to enter a metering zone but cannot exit due to a reduction in capillary dimension at the outflow. Excess sample is purged out of the feed channel and then a higher pressure applied to force the defined volume of sample from the sampling region past the restriction and into the reaction zone. Such systems are complex and rely on an additional motive force to capillary action for fluid flow. They are thus not suited to pure capillary systems.

PCT/GB2012/050575 describes an alternative approach more suited to microcapillary devices, and not reliant on external propulsive forces. The basis of the system is to use a side passage leading off from a main passage to hold any excess sample. By controlling air egress from the passages using remote valves, sample is directed into the side or main passage. In use, an excess of sample is added to a sample port and is directed along a main passage, until it reaches the junction with the side passage. By controlling the remote valves, the sample is caused to flow into a respective side passage. Flow stops when the sample port is empty. The length of capillary from the sample port to the junction therefore defines the sample volume for the assay, with excess sample being trapped in the side passage. Sample metering is therefore achieved by capturing a defined volume from the rear end of the fluid volume, with the excess being discarded from the front. This approach is very effective and suited to microcapillary systems.

The present invention aims to provide an improved sample metering device.

### SUMMARY OF THE INVENTION

The present invention provides a sample metering device for a liquid sample, the device comprising 1) a sample metering element comprising i) at least one capillary passage with a first inlet, a second inlet, and a capillary passage outlet; ii) a side passage extending from the capillary passage part way along the length thereof and leading to a side passage outlet; and 2) a control element comprising i) first sealing means operable to releasably seal the capillary passage outlet; and ii) second sealing means operable to releasably to seal the side passage outlet.

In a preferred embodiment, the sample metering device may comprise a sample application region for receiving, and if appropriate storing, a liquid sample to be tested, for entry to the capillary passage via the first inlet. The sample metering device may also comprise a fluid application region for receiving and if appropriate, storing, a fluid (e.g. a chase buffer) for entry to the capillary passage via the second inlet.

Provision of a second inlet enables the application of a buffer or other non-sample fluid to the capillary passage, after the test volume of sample. The second inlet is preferably in the same line of flow as the first inlet. The second inlet is located between the first inlet and the intersection with the side passage. The location of the second inlet determines the amount of sample test volume which is caused to move down the capillary passage by the application of fluid to the second inlet, as any sample between the first and second inlet will not form part of the test volume. Thus to maximise the test volume it is preferably located immediately downstream of the first inlet. Preferably, the second inlet is located within at least 15 mm, at least 7 mm or at least 5 mm of the first inlet.

The second inlet may be in fluid communication with a fluid application region and/or a fluid well (e.g. a capsule) for example provided in a fluid dispensing means. Preferably, a fluid application region and/or a fluid well supplying the second inlet are distinct from a sample application region and/or a sample well, supplying the first inlet. However, in certain embodiments, they may be the same.

Use of a second inlet, separate to the first inlet, is advantageous in those situations where a gross excess of sample is added to the device. In such situations, the side passage can become full while sample is still in a sample well or sample application region. When buffer is introduced, sample can then enter then capillary leading to an excess of sample being introduced into the assay. The provision of a second inlet, downstream the first (sample) inlet neatly avoids this problem as chase buffer facilitates flow along the capillary of only the test volume and not excess sample.

In an embodiment, a third inlet may be provided. A third inlet may be used for addition of reagents. A third inlet is preferably provided downstream of the second inlet. Preferably, a third inlet is positioned downstream of the intersection of the capillary passage with a side passage. Preferably, where the third inlet is used for addition of reagents to the capillary passage, the exact location of the third inlet will depend upon the time point of the assay at which the reagents require addition. With knowledge of the geometry of the capillary passage, the location can be determined depending upon the assay time required prior to or after reagent addition. Thus, for example, where it is desirable to maximise the reaction time between the sample and a reagent, the third inlet may be positioned close to, preferably immediately downstream of the second inlet. Where the reaction time required is shorter, a third inlet may be positioned further downstream from the second inlet, close to a signal measurement or detection zone. Preferably, a third inlet may be provided between the intersection with a side passage and a signal measurement or detection zone. In an embodiment, a third inlet may be provided a distance of between 60-250 mm, preferably 80 to 230 mm, preferably 100-200 mm, preferably 120-180 mm downstream of the intersection with side passage or the second inlet.

The section of capillary passage between a second inlet and a signal measurement or detection zone is often referred to as a reaction zone. A third inlet may be provided between a second inlet and the start of a reaction zone, or within a reaction zone.

The provision of a third inlet allows for the addition of reagents to the device as liquids, and therefore avoids the requirement to deposit reagents in a capillary passage in a dried and reconstitutable form. Therefore, problems associated with deposition of reagents and their reconstitution are avoided. In addition, reagents supplied in liquid form directly to the capillary passage are able to mix immediately with the sample and any buffers, thus increasing the time available in the capillary passage for reaction. Reagents include those described herein.

The present invention is typically applicable to capillary devices in which fluid flow is passive, i.e. it is not controlled by an external force. The sealing means of the device act as remote (off-line) valves, which control passive flow of sample liquid through a passage of the element. Thus, the sealing means are releasably movable between a position in which the sealing means are positioned to seal an outlet and a position in which the outlet is not sealed, to stop or allow liquid sample flow, respectively. By remote or off-line is meant that a valve (sealing means) is capable of controlling flow of a liquid sample (i.e. stopping or slowing, or resuming flow) without requiring contact between the sealing means and liquid sample or fluid. The sealing means are external to a capillary passage. When a liquid sample is provided via the first inlet, liquid will flow along the capillary passage only when the first sealing means is operated not to seal the outlet of the capillary passage. When the first sealing means is operated to seal the outlet, then fluid flow along the capillary passage is not possible. Thus operation of the sealing means can be used to control fluid flow in a capillary passage and/or side passage.

The invention is used by applying a liquid sample to a sample application region, with the first sealing means operated to seal the capillary passage outlet and the second sealing means operated not to seal the side passage outlet. Liquid sample is introduced to the capillary passage via the first inlet, and flows along the capillary passage by capillary action only as far as the intersection with the side passage, because the capillary passage outlet is sealed. Liquid is, however, able to flow into and along the side passage because the side passage outlet is not sealed. The capillary will continue to flow and any excess liquid above the test volume will begin to fill the side passage. Flow stops when all sample has drawn into the capillary passage (the back pull in the capillary then equalling the forward pull) or the side passage is full. In this way, the capillary passage is filled with sample liquid to a defined point (the intersection with the side passage). Any excess sample over the test volume is contained within the side passage. If the sample volume is too small, liquid sample will not reach the side passage. Thus, it is preferred that sample in slight excess of the test volume is added to the device. Preferably, the test volume is a pre-determined volume, appropriate to the assay type. To aid capillary flow of the sample along the capillary passage, a chase buffer is added to the capillary passage via the second inlet. In an embodiment, prior to addition of a chase buffer, the first inlet is sealed to prevent any backflow of sample. In an embodiment, after sample addition, the sealing means function to seal both the capillary passage and side passage outlets. Upon addition of buffer to the second inlet, the sealing means are operated to not seal the capillary passage outlet, and sample and buffer flows along the capillary passage. Preferably, the sealing means continue to seal the side passage outlet. In an alternative embodiment, the conditions of the sealing means are reversed prior to release of buffer (and thus there is no “holding” position where both main passage and side passage outlets are sealed), with the first sealing means functioning not to seal the capillary passage outlet and the second sealing means functioning to seal the side passage outlet. The buffer follows flow of the sample along the passage. The second inlet may be sealed after addition of buffer, for example to avoid backflow and in particular where a third inlet is provided for reagent addition, downstream of the second inlet. The liquid in the capillary passage is then free to flow further along the capillary passage, for example by capillary action. No further flow will take place along the side passage, including back-flow towards the capillary passage. The volume of sample liquid from the second inlet to the intersection with the side passage is referred to herein as a test volume.

The sample metering device has the advantage that the leading edge of the sample liquid is not used as the test fluid, but is removed into a side passage as excess fluid. Thus the defined sample does not leave the main capillary, and so can continue to flow along the capillary passage for the assay. No complex fluidics or additional sources of motive force are required other than capillary force. Further, the design is such that excess sample is contained safely within the device preventing any external contamination.

The sample metering device provides a simple, convenient and reliable means for obtaining a predetermined volume of a liquid sample in a capillary passage (the test volume). The size of the test volume depends on the cross-sectional area and length of the capillary passage between the second fluid application inlet and the side passage inlet. The size of the capillary passage between the second fluid inlet and side passage inlet (the test volume) may be of any suitable size, depending upon the purpose of the assay. Preferred test volumes range from 1 to 200 μl, more preferably between 1 and 150 ∥l, more preferably between 1 and 50 μl, more preferably between 1 and 20 μl, more preferably between 1 and 10 μl.

The sealing means act as remote valves, the operation of which serves to control flow in the capillary and where provided, the side passages. The sealing means are provided externally to the passages, and therefore are capable of controlling flow of a liquid sample in the capillary passage without contact of the sealing means with the liquid sample. Thus, the sealing means are effectively off-line valves for control of liquid sample flow, such that they are capable of controlling flow of a liquid sample in a capillary passage without requiring contact between the sealing means and liquid sample (i.e. they operate at a distance from the leading edge of the fluid).

The sealing means operate to open or close an outlet, either partially or fully. Sealing means may also be provided to open or close (fully or partially) an inlet. The outlet sealing means and inlet sealing means may be the same or different. A sealing means may be provided to seal one or more outlets; and a further sealing means may be provided to seal one or more inlets. Alternatively, a sealing means may seal a combination of one or more outlets and one or more inlets (for example, the inlets and outlets for a main passage and associated side passage).

Sealing means for use in the present invention must be sufficient to provide an air tight seal to a passage, when in a sealing relationship with an outlet. An air tight seal will substantially or completely stop fluid flow in the passage to which the sealed outlet is related.

The invention is preferably applicable to any capillary pathway device, and finds application in a variety of microfluidic applications that require delivery or control of one or more liquids. Thus, it may be applicable to a microfluidic device, including for example inkjet printheads, DNA chips, lab-on-a-chip technology, biotechnology based arrays, and microfluidic based sample assays, micro-propulsion, and micro-thermal technologies. In a preferred embodiment, the sample metering device is a diagnostic assay device, preferably a point-of-case diagnostic device. A diagnostic assay device is preferably a single layer device i.e. where the capillary passages lie in a single plane. The device may be provided in combination with devices which rely on other motive forces than capillary action to drive fluid flow, preferably as an integrated device. In such embodiments, reference to capillary action and capillary passages herein include within their scope any applicable fluid flow action or passage.

The invention is preferably used for sampling based assays, where a measured volume of liquid is removed from a larger volume and assayed. The present invention is particularly suited for use in assaying a sample liquid for a particular component. Whilst it may be suited to biological and non-biological applications, it is particularly suited to the former. Thus, the present invention is preferably for use in assaying a biological sample for a particular component, for example an analyte. Typically, assays for which the present invention may be used are microfluidics-based assays, including for example agglutination based assays, capture-based assays such as ELISA assays, and coagulation based assays. The assays may be quantitative or qualitative. The present invention may be suitable for use with any liquid sample. Preferred biological samples for assay using the present invention are blood (whole blood or plasma) and urine.

The invention finds particular application in sample metering devices having one or more capillary passages for testing for the presence of a component of interest in a liquid sample, e.g. blood or other body fluid, as is well known in the art, e.g. diagnostic assays, such as the agglutination assays disclosed in WO 2004/083859 and WO 2006/046054.

The sample metering element of the device may include more than one (i.e. two, three, four, five or more) capillary passages, each with an associated side passage. Preferably, each capillary passage comprises a first and second inlet. Optionally, each passage may comprise a third inlet. Alternatively, a common first inlet and/or a common second inlet may be provided for any two or more passages. Where provided, a third inlet may be common for any two or more capillary passages. In such an embodiment, a common capillary passage may be provided, which divides into two or more capillary passages, preferably downstream of the first or second or third inlet. In such an embodiment, therefore, sample metering takes place in a shared portion of two or more passages. Depending on their purpose, it may not be necessary for all capillary passages to comprise a second inlet and/or third inlet, although it is preferred that they do so. Thus, in an element having two or more capillary passages, there may be one or more capillary passages having a first and second inlet, and one or more having only a first inlet.

Sealing means may be provided for each capillary passage outlet and side passage outlet. A sample metering element as discussed above typically includes at least two side-by-side capillary passages (and associated features), which in certain embodiments may constitute a test passage and a control passage, or may each constitute a test passage. For any two or more capillary passages, it is preferred that the second inlet is provided at a position such that the test volume drawn down the capillary passage in each capillary is the same. Thus, for example where two or more capillary passages have the same geometric dimensions in terms of width and height, a second inlet will be provided at the same distance downstream from the first inlet, for each of said capillary passages. However, it is envisaged that for any different two or more capillary passages in the same element, the test volume may be different, i.e. determined by a different positioning of the second inlet or junction with the side passage. Multiple similar test passages may be provided, e.g. for simultaneous testing of a single sample for multiple components of interest.

An element of the present invention may comprise reagent deposited in one or more capillary passages. Preferably, reagent may be deposited in a test (assay) and/or a control passage (i.e. main capillary passages). Typically, side passages which are provided for removal/storage of excess sample do not require reagent deposited therein. Reagent is preferably deposited in a reaction zone or immediately upstream of a reaction zone. Any suitable methods may be used for deposition of reagent in a capillary passage. In a preferred embodiment, sections of capillary passage comprising reagent described herein are inserted between other sections of passage during manufacture. Reagents laid down in a capillary passage may include, for example, agglutination reagents, antibodies, and labels. Other reagents include buffers, and any other assay components. Particularly in a sample testing device, reagent may be capable of causing a reaction with a component of interest. In the case of the arrangement described above, the reagent system is typically deposited in a capillary passage. Where a side passage is provided for metering, any test reagent is preferably deposited downstream thereof. Other sample treatment reagents (for example, an anticoagulant) may be provided upstream of the junction with a side passage.

In the present invention, a capillary passage may have any suitable geometry, typically dictated by the array type. For instance, the passage may be straight, curved, serpentine, U-shaped, etc. The cross-sectional configuration of the capillary passage may be selected from a range of possible forms, e.g. triangular, trapezoidal, square, rectangular, circular, oval, U-shaped, etc. The capillary passage may have any suitable dimensions. Typical dimensions of a capillary passage for use in the invention is a depth of 0.1 mm to 1 mm, more preferably 0.2 mm-0.7 mm. The width of a passage may be of similar dimensions to the depth. Where the passage is V-shaped, for example, the profile may be that of an equilateral triangle, each side having a length of between 0.1 and 1 mm, more preferably between 0.2 and 0.7 mm.

Where more than one capillary passage is provided in a device, the geometry of each may be independently selected and two or more may be the same or different.

The side passage may also be a capillary passage or it may be a passage of non-capillary proportions. It may also be referred to herein as an overflow passage. The size and shape of a side passage is typically dictated by the volume of sample it is required to accommodate. As the side passage is provided for storage of surplus sample, the same requirements of a test capillary passage, e.g. in terms of flow, reagent depositions, surface preparation, may not necessarily apply. The geometric and cross-sectional configurations of a side passage may be dictated by required volume to be held and the overall configuration of the device. The side passage may be wider or able to accommodate a larger volume than the test volume. For reasons including flow of sample, the side passage may be wider than the capillary passage. Preferably, the side passage has a volume of between 1 and 100 μl.

Typical dimensions of a side passage for use in the invention is a depth of 0.1 mm to 1 mm, more preferably 0.2 mm-0.7 mm, most preferably approximately 0.5 mm. The width of a passage may be of similar dimensions to the depth. Typically, a side passage will have any length suitable depending upon the estimated sample size and the metering requirement, and also dictated by the shape and form of the device as a whole. Preferably, the side passage may have a length of between 20 and 100 mm, more preferably between 20 and 80 mm, more preferably approximately 60 mm.

The side passage may branch from the capillary passage in any direction, and may adopt any geometric configuration, for example it may be straight, curved, serpentine, U-shaped etc. It may extend parallel to the capillary passage, or perpendicular thereto, or otherwise. Preferably, the side passage is configured such that the side passage outlet is in close proximity to the capillary passage outlet, such that both may be operated by a single control element or sealing component bearing sealing means. The cross-sectional configuration may be any suitable configuration, for example trapezoidal, triangular, horizontal, square, rectangular, circular, oval, or U-shaped etc.

In a preferred embodiment, a capillary passage may comprise means for detecting presence or absence of sample liquid. Such means may be used to communicate to the user that further operation of the device (e.g. sealing or not sealing an outlet) is necessary, and/or to monitor flow for the purpose of obtaining assay results. A side passage may comprise means for detecting the presence or absence of sample liquid, preferably to confirm that sample liquid has entered the side passage, and therefore the test volume is present in the main capillary passage (i.e. the volume is not short or insufficient). Suitable detection means for use in the invention may include, in a simple form, for example a viewing window, or other means such as an electronic or optical sensor. A detection means may be operably linked to a control element, for operation of a sealing means of the device.

Functionally, the configuration of the side passage must be such that it supports capillary flow, such that flow into the side passage can be remotely (i.e. without contacting the fluid and/or the inside of a capillary passage) controlled by sealing or opening the side passage outlet.

In addition to the first and second inlet and any third inlet of a capillary passage, a capillary passage may further comprise one or more additional inlets at one or more positions along the length of a capillary or side passage, for example for deposition of reagents in a passage or where branched (e.g. converging) channels or passages are provided. Typically, however, these additional inlets (i.e. other than the first, second or third inlets) are usually sealed during manufacture and not operable or accessible by the user during performance of a test.

Inlets typically mean entry holes. Preferably, these are in fluid communication with a sample or fluid application region, or a well preferably in direct fluid communication so that fluid can enter a capillary passage. If in indirect communication, this is preferably via non-capillary passages or means. An inlet is positioned in a capillary passage at suitable positions from which fluid flow will start. Typically, this will be in close proximity to a well, or control element which may be integrated with the device. In an embodiment, the first and second and any third inlets may be distinguished from other inlets of the device because they are each positioned to receive liquid during operation of the device, or to be in fluid communication with a fluid application region and/or where provided, a well which holds sample or other fluid during operation of the device. A well or fluid application region may be part of the sample metering element, or may be a separate component which can be integrated or forms part of the device, for example as a control element as further described herein.

An application region is an area designed to receive fluid, for example from a well, or directly from supply. An inlet may form part of an application region, or may be in fluid communication therewith, for example via a short passage. For example, an application region may be a widened section forming an entry to an inlet to which fluid or sample is applied, or may be part of a storage well. Thus, an application region may form part of the sample metering element or part of a control element which may be integrated with the device. In a preferred embodiment, an application region may be an indented region in a planar sample metering element, for example as further described below. Alternatively, it may be a through hole in a sample metering element, leading to an inlet on an opposing surface thereof.

An inlet must be of a dimension which enables it to receive liquid. Preferably, for a sample testing device, an inlet will have an opening diameter in the region of 1 and 4 mm, preferably between 1 and 2 mm. For other applications, larger or smaller inlets are envisaged.

Typically, an outlet of a capillary passage or side passage is provided to enable flow through a passage, for example by capillary of by a motive force, typically so that air can leave the passage. An outlet may be provided at a distal end of a capillary or passage, although an outlet may be provided at one or more positions along the length of a capillary or side passage. An outlet may not need to accommodate liquid flow therethrough. Preferably, it is able to accommodate air flow therethrough, sufficient to maintain flow of a liquid through the respective passage. For a sample testing device, an outlet may be of smaller dimensions than an inlet. An outlet may typically have an opening diameter of between 0,15 mm and 4 mm, more preferably between 0.3 and 2 mm. For other devices, larger or smaller outlets are possible. An outlet is typically only in fluid communication with a passage.

Outlets and inlets may have a raised skirt around the circumference, with the opening being central thereto. Outlets may be provided on the upper surface of the sample metering element.

The sample metering element conveniently comprises a moulded plastics component, e.g. in the form of a generally planar element having grooves in one surface thereof to define the capillary passage(s) and side passage(s) when sealed by a cover member.

As previously mentioned, one or more wells may be provided, for holding sample or fluid (e.g. buffer or reagent). Preferably, a well is provided for each liquid which is to be provided in the assay, i.e. at least a sample well and a fluid well. Each well is preferably in fluid communication with a respective sample/fluid application region, and/or with a respective first or second inlet. A well may supply two or more capillary passages. A well may be any suitable shape and size, suitable for receiving and retaining liquid sample.

Each well may be independently formed within, or as part of the sample metering element, for example as a concave region leading to an inlet, or may be formed upstanding therefrom, for example defined by a walled enclosure. In these embodiments, the base of the well may comprise a sample/fluid application region of the sample metering element. Alternatively, all or part of a well may be provided in the control element. Alternatively, a well may be provided as a separate element, for example as a capsule, which may be integrated with the sample metering or control element or device.

Where two or more wells are required, for example for supply of a sample to a first inlet and fluid (e.g. chase buffer) to a second inlet, and optionally reagent to a third inlet, these may be independently provided either in a sample metering or control element or provided separately, for example as described above. Thus, one or more wells may be provided as a separable element or control element and/or one or more wells may be provided as part of the sample metering element. In a preferred embodiment, at least a sample well and a fluid well are provided as a (one or more) separate element, e.g. a capsule, preferably in a single separable element.

A well may be of any suitable size and shape. Preferably, a well is configured to aid drainage toward a fluid application region or inlet. For example, the base of a well may be funnel shaped, i.e. configured such that it slopes toward an inlet from all directions. This configuration aids drainage of sample or fluid into a capillary passage. Preferably a well comprises a suitable form of cap or cover, which is preferably removable, and may constitute one or more side walls of the well.

In an embodiment, a cap of a well may comprise a liquid inlet for passage of liquid to an application region and/or inlet. Alternatively, a cap or cover of a well may form part of a control element or sealing component.

A well may comprise features, for example micropillars, to aid liquid flow into a capillary passage. Suitable features will be known to a person skilled in the art.

The sealing means (and additional sealing means if present) may be located on a control element, movable to cause operation of the sealing means. Each sealing means may be located on a respective control element. Preferably, however, each pair of first and second sealing means are located on a common control element. Further pairs of first and second sealing means may be provided on the same control element as first pair of first and second sealing means, or on different control elements. In a preferred embodiment, all sealing means for a device are provided on, or operably linked to, a common control element. In a preferred embodiment, a common control element may be a seal, as shown in FIG. 7.

The control element is typically arranged for rotary movement or linear movement (axially, towards and away from the outlet, or laterally, in a sliding action).

In embodiments having two or more capillary passages, one or more of said capillary passages having a side passage, one or more pairs of first and second sealing means may be provided. One or more pairs of sealing means may be constituted by a single sealing component or provided on a control element. A sealing component may be provided on a control element. Such a component or control element is moveable between a first position in which the first sealing means is positioned to seal a capillary passage outlet and the second sealing means is positioned not to seal a side passage outlet and a second position in which the first sealing means is positioned not to seal the side capillary passage outlet and the second sealing means is positioned to seal the side passage outlet. In an embodiment, two or more first sealing means may be constituted by a single sealing component or provided on a control element. A sealing component may be provided on a control element. Such a component or control element may be moveable between a first position in which the first sealing means is positioned to seal a capillary passage outlet and a second position in which the sealing means are positioned not to seal a first capillary passage outlet. Two or more second sealing means may be constituted by a single sealing component or provided on a control element. A sealing component may be provided on a control element.

Such a component or control element may be moveable between a first position in which the sealing means are positioned to not seal a side passage outlet and a second position in which the sealing means are positioned to seal a side passage outlet. In an embodiment, two or more first sealing means and two or more second sealing means, or two or more components may be provided on the same control element, which is moveable between a first position in which the first sealing means is positioned to seal the first capillary passage outlet and the second sealing means is positioned to not seal the side passage outlet; and a second position in which the first sealing means are positioned not to seal the first capillary passage outlet and the second sealing means are positioned to seal the side passage outlet.

Alternatively, respective first and second (and possibly further) sealing means may be provided for each of the capillary passage outlets, each operable for sealing the associated outlet or not. For instance, each sealing means may be located on a respective control element, e.g. axially movable towards and away from the associated outlet. As a further possibility, the sealing components may be located on a common control element, e.g. arranged for rotary or linear (lateral) motion, movable between a first position in which the first sealing means is in sealing relationship with the first capillary passage outlet, with the second sealing means not in sealing relationship with the second capillary passage outlet; and a second position in which the second sealing means is in sealing relationship with the second capillary passage outlet, and the first sealing means is not in sealing relationship with the first capillary passage outlet.

As described above, sealing means may be provided for sealing of an inlet. Two or more inlets may be sealed by a single sealing means, or first, second, and further sealing means may be provided, each to seal an inlet. Any inlet sealing means may also seal one or more outlets. Thus, a sealing means may be common to a first, second or further inlet and a first, second or further outlet. Inlet sealing means may be provided on a control element. A control element may comprise one, two, three of more sealing means.

In an embodiment, sealing means may operate in a binary manner between two positions, a position in which an outlet is sealed and a position in which an outlet is not sealed. In another embodiment, a sealing means may operate in a quantitative manner such that the sealing means may be operated to partially close an outlet, such that the rate of flow of the liquid sample in a passage may be controlled depending upon the degree to which the outlet is opened or closed. For example, the sealing means may be operated to slide across the vent, such that the rate of flow of the liquid sample is slowed as the outlet is in a partially closed position. In an embodiment, the sealing means may adopt any one or more positions which partially close an outlet to alter the rate of flow in a passage. These embodiments may apply to both the first and second sealing means of the invention.

Conveniently, one or more outlets may be grouped together. Preferably the pair of outlets for the main passage and side passage may be located within a close proximity so the respective sealing means are operable by a single control element. In an embodiment, two or more side passage outlets may be grouped in close proximity, and two or more main capillary passage outlets may be grouped in close proximity, so that each group may be controllable by a single control element. Preferably, outlets or groups of outlets may be located in close proximity to the fluid application region.

In an embodiment, a sample metering element of the invention may comprise a first capillary passage having a first inlet, a second inlet, and a capillary passage, and a second capillary passage having an inlet and which intersects the first capillary passage at a downstream point of convergence such that the first and second capillary passage have a common outlet. When liquid is flowing in the second capillary passage, provided the liquid is upstream of the point of convergence, liquid can flow in the first capillary passage. However, when liquid in the second capillary passage reaches the point of convergence, this blocks the outlet from the first capillary passage and prevents further flow of liquid in the first capillary passage, as air can no longer escape from the first capillary passage via the common outlet. Liquid can continue to flow in the second capillary passage. By arranging the liquid flow rates so that liquid in the second capillary passage reaches the point of convergence before liquid in the first capillary passage reaches this point (as determined by factors including the geometry and architecture of the two capillary passage and the viscosity of the liquids in the passages), the flow of liquid in the second capillary passage can be used to control the flow of liquid in the first capillary passage. The liquid in the second capillary passage thus acts indirectly on the liquid flow in the first capillary passage and means for measuring the extent of liquid flow along the first capillary passage.

Thus, for example, the liquid flow in the first capillary passage can be stopped at the point when the liquid in the second capillary passage reaches the point of convergence. This point is an appropriate time at which the extent of flow of liquid in the first capillary passage from the inlet toward the outlet can be measured. This is a measurement of the distance travelled from the inlet. This has the advantage that liquid flow in the first capillary passage, typically a test capillary passage, is stopped and does not “creep”, such that less false results are obtained. Thus, a method typically involves determining the extent of liquid flow in the first capillary passage after the liquid in the second capillary passage has passed the point of convergence and flow in the first pathway has stopped. Preferably, a method of the invention may further comprise using the measurement of distance travelled to determine the amount of a substance of interest in a sample.

Any suitable measurement means or mechanism may be provided in the device to measure the extent the liquid in a first passage has travelled and may represent distance or analyte concentration (determined by means of a predetermined dose response). Where the measurement mechanism comprises distance markings may be provided in any suitable unit (mm, cm, inches or fractions of inches for example), on a linear, logarithmic or other scale. Alternatively, a machine vision system may be used. Use of distance markings for visual reading provides a simple, cheap approach.

In a simple case, distance markings may be provided along at least part of the length of the first capillary passage. The extent of flow can be determined by reference to the markings, either by eye or by a machine vision system. Preferably, distance markings may extend along at least the part of the first capillary passage until the point of convergence with the second passage.

Preferably, distance markings are provided from the inlet of a passage to a point of convergence with a second capillary passage. In some embodiments, measuring means may be provided in relation to a third capillary passage, for example for the purpose of making relative measurements.

A control element may be easily manipulated by the user. A control element may be manually operable by a user, or automatically operable, for example prompted by one or more sensors associated with detection means in the device, or a timer. In a preferred embodiment, a control element sits on an upper surface of the sample metering element, with sealing means provided on the lower surface of the control element such that in position, the sealing means sit against the upper surface of the sample metering element and can function to open and close outlets. The sealing means may be an integral part of the control element, or may be separable therefrom.

A control element may be of any suitable shape. For example, it may be a rotatable element, for rotational movement about a pivot, or a formed for linear movement, e.g. a sliding motion along the location of outlets. Preferably, it desirably comprises a generally circular element, conveniently positioned for rotation with or around a pivot of the element. Other suitable shapes and forms of the control element and fluid application region are included within the scope of the invention. Grooves and elements may be provided on the control element and upper surface of the device to permit limited movement of the control element.

A control element may comprise a well, or serve as a cap for a well. It may include a liquid inlet for passage of liquid to a fluid or sample application region, and thus a first and/or second inlet. Preferably, the liquid inlet is in fluid communication with a fluid or sample application region or well only when a control element is in selected positions, e.g. selected rotary or linear positions, as further described below.

In an embodiment, a well side wall desirably includes a main cylindrical portion e.g. a part-cylindrical portion such as a part circular cylindrical portion, with a wider extension portion, e.g. a part-cylindrical portion such as a part circular cylindrical portion, with the extension portion base including an opening leading to the inlet of the capillary passage(s). The control element, e.g. a rotatable cap, desirably includes a cooperating annular groove on the underside, dimensioned to fit around the well side wall, with the annular groove having a widened portion to accommodate a well side wall extension portion, with the control element having a fluid entry opening overlying the widened portion of the groove. The arcuate length of the widened portion of the control element groove is larger than the arcuate length of a well side wall extension portion, to permit limited rotary movement of the control element relative to a well.

As mentioned above, sealing means or sealing components may carried on or form part of the control element, e.g. on the underside thereof. The sealing means or components may be constituted by elements, e.g. of soft material, e.g. a soft thermoplastic material such as an elastomer, standing proud of or forming part of the control element underside. In a preferred embodiment, a sealing component is a circular, planer element which sits adjacent to the underside of the control element. Alternatively, sealing means or a sealing component may be provided on a flange which extends outward from a side wall of a control element, preferably substantially perpendicular thereto. Sealing means may be feet, provided on a flange.

Markings and/or stops are conveniently provided to indicate the various positions of the control element, to facilitate operation by a user. These may be provided preferably in the capillary passage device.

End stops are desirably provided to limit the movement of the control element.

The control element is movable with respect to the sample metering element between at least the following positions:

i) a first, inactive position in which the first sealing means are positioned not to seal the capillary passage outlet(s) and the second sealing means are positioned not to seal the side passage outlet(s); and

ii) a second metering position in which the first sealing means are positioned to seal the capillary passage outlet and the second sealing means are positioned not to seal the side passages outlet(s); and

iii) an optional third holding position in which the first sealing means are positioned to seal the capillary passage outlet(s), and the second sealing means are positioned to seal the side passage outlet(s);

iv) a fourth position in which the second sealing means are positioned to seal the side passage outlet(s) and the first sealing means are positioned not to seal the capillary passage outlet(s).

Preferably, in the first, inactive position the sample application region or well is concealed to a user and the second liquid inlet is not in fluid communication with the fluid application region or well; in the second metering position the sample application region is exposed to a user; in the third, holding position the first inlet and/or the sample application region are sealed to prevent backflow of sample; in the fourth position the second inlet is in fluid communication with the fluid application region and/or well. Access to the first inlet, second inlet, third inlet if present and application regions or wells in each of these positions may be independently controlled by a control element or by other means.

Desirably, a control element is movable with respect to the sample metering element between

i) a first, inactive position in which the sample application region or well is concealed to a user by the control element; a second liquid inlet is not in fluid communication with the fluid application region or well; the first sealing means are positioned not to seal the capillary passage outlet(s) and the second sealing means are positioned not to seal the side passage outlet(s); and

ii) a second position in which the sample application region is exposed to a user and the first sealing means are positioned to seal the capillary passage outlet and the second sealing means are positioned not to seal the side passages outlet(s); and

iii) an optional third holding position in which the first sealing means are positioned to seal the capillary passage outlet(s), and the second sealing means are positioned to seal the side passage outlet(s); and the sample application region and well is concealed; and

iv) a fourth position in which the second inlet is in fluid communication with the fluid application region and/or well;

v) a fifth position in which the second sealing means are positioned to seal the side passage outlet(s) and the first sealing means are positioned not to seal the capillary passage outlet(s).

A third inlet may remain sealed during positions i) to v) above, and may be opened for addition of reagent after opening of the capillary passage outlet.

Thus, the first inactive position is used for storage or transit of the device, for example when provided as a complete device rather than as a kit of parts. It is the position adopted when the device is not in use. In the second position, the device is prepared for use by opening the sample application region, for example by operation of the control element. In the second position, the side passage outlet is open, and so sample applied the sample application region in fluid communication with the first inlet flows along the capillary passage and into the side passage. In the optional third position, both the capillary passage outlets are closed to prevent flow of excess sample into the capillary passage. The first inlet and/or sample application region may also be closed, to prevent backflow of sample toward the inlet. Optionally, whilst in the holding position, the fluid may be brought into contact with the second inlet, for example by operation of fluid dispensing means. This may constitute the fourth position. The capillary passage outlet can then be opened, allowing fluid to enter the second inlet (the first inlet remains closed), such that fluid follows the test volume of sample along the capillary passage toward the capillary passage outlet in the assay. The side passage outlet may be sealed. In an alternative embodiment, the release of liquid from the fluid dispensing means into the second inlet may take place immediately after reversal of the sealing means (fifth position).

Preferably, the capillary passage outlets are opened to allow forward flow at approximately the same time as fluid is released into the second inlet (i.e. the fourth and fifth positions can occur simultaneously or almost simultaneously). Preferably the operator does not halt movement between positions 2 and 5.

Flow of the liquid sample may be slowed, stopped and caused to resume flow by appropriate movement of the first sealing means, any number of times (one or more) during a single assay, by controlling flow in a second capillary passage, for example as described above. This may be desirable in a multi-step assay, for example at a predetermined point to enable a reaction to occur before allowing the fluid to proceed to the next step. The invention can also be used to direct fluid, or a portion of fluid, along different capillary passages in a device.

More preferably the sealing means for the capillary passage and side passage can be releasably operable.

In embodiments having two (or more) capillary passages, additional sealing means or components may be provided as required, conveniently located on a control element as discussed above.

The invention also provides a method of metering a liquid sample, comprising:

a) providing a sample metering device comprising (1) a sample metering element comprising (i) at least one capillary passage with a first inlet, a second inlet and a capillary passage outlet; (ii) a side passage extending from the capillary passage partway along the length thereof and leading to a side passage outlet; and (2) a control element comprising (i) first sealing means operable to releasably seal a capillary passage outlet; and (ii) second sealing means operable to releasably seal a side passage outlet;

b) operating the device to reveal the sample application region or sample well, and operating the control element to position first sealing means to seal the capillary passage outlet(s) and to position second sealing means not to seal the side passage outlet(s);

c) applying liquid sample to a sample application region of the sample metering element;

d) operating the control element to position first sealing means to seal the capillary passage outlet and to position second sealing means to seal the side passage outlet(s); and operating the device to seal the first inlet and/or sample application region; to hold liquid sample in the capillary passage and side passage without backflow to the sample application region or without excess sample entering the capillary passage;

e) operating the device to place the second inlet in fluid communication with a fluid application region or fluid well; and releasing fluid from a fluid well;

f) operating the control element to position first sealing means to not seal the capillary passage outlet(s) and to position second sealing means to seal the side passage outlet(s);

g) optionally adding reagent to the capillary passage via a third inlet.

Preferably, the sample metering device is as defined herein.

In an aspect, the present invention provides a control element for controlling flow of fluid in a sample metering element comprising i) a first capillary passage with a first inlet, a second inlet and a capillary passage outlet; wherein the control element comprises first sealing means operable for releasably sealing the capillary passage outlet, and second sealing means for releasably sealing the side passage outlet.

Preferably, the control element is as described herein. Preferably, it is adapted to fit onto the sample metering element in a releasable manner.

In an aspect the present invention provides a sample metering element as defined herein.

In an aspect, the present invention provides a kit or package comprising control element is as described herein, and/or a sample metering element as defined herein, and optionally one or more of a calibration chart, buffers, capsules, reagents including agglutination regents, reagent application means, instructions for use, a reader, a timer, and/or a power supply.

Preferred features and embodiments of the sample metering device (e.g. the reagents, control element, well, sealing means and sealing components etc) may apply, mutatis mutandis, to the combined device or kit, as provided herein (e.g. features and embodiments relating to reagents, capillary devices, inlets and outlets, wells, sealing means, and the control element).

In an embodiment, the device comprises fluid dispensing means, comprising a rupturable, sealed container of fluid to be dispensed, rupturing means for rupturing the container and releasing the contents, the container and/or rupturing means being arranged for relative movement between a first position in which the container is intact and a second position in which the container is ruptured. Fluid dispensing means may be provided by the sample metering element, the control element or both. In any device, a fluid dispensing means may comprise two or more containers, for supply of the same or different fluids to the assay (eg buffer and reagent), or a device may comprise two or more fluid dispensing means as described herein. Each fluid dispensing means may provide fluid to the same or a different inlet (e.g. second and third inlets)

Preferably, the fluid is a buffer, which serves to assist movement of the liquid sample in the passages, although the fluid may be any fluid required for performance of the assay. Where it is used to assist movement in a capillary based assay, the buffer may be referred to as a chase buffer. Any suitable buffer may be used, for example, a solution of Ficoll polymer, preferably a 1% by weight solution of Ficoll polymer in deionised or distilled water (Ficoll is a Trade Mark), which enables the reaction to be carried out with a smaller volume of sample than is required to flow around the entire capillary system to determine a test result. The fluid may be reagent, as described herein.

The rupturable, sealed container of fluid and/or rupturing means, e.g. in the form of projections, may be movable with respect to each other for release of fluid for passage to the sample metering element. Operating means serve to move the container, rupturing means or both into a second position in which the container is ruptured. The operating means may be a plunger, carrying at one end either the container or rupturing means. Operating means may be arranged for rotary movement e.g. about a pivot, or linear movement (axially or laterally).

Preferably, at least a portion of the container wall is rupturable, e.g. being formed of rupturable foil such as a polyolefin film. The container may be made entirely of rupturable material e.g. being in the form of a capsule. As a further possibility, the container may mainly or partly comprise rigid material, e.g. a rigid plastics material, with a rupturable portion, such as a rupturable wall or base, e.g. of rupturable foil such as polyolefin film.

Any suitable rupturing means may be provided. Preferably, the rupturing means conveniently comprise one or more projections, preferably having sharp tips. The projections are desirably tapered, and preferably have features to facilitate fluid release e.g. being of scalloped configuration. Desirably a plurality of projections are provided.

Second rupturing means may similarly be provided, arranged to rupture an opposing portion of the container, to allow air to pass into the container. This aids flow of fluid out of the container. The second rupturing means may be provided as for the first rupturing means, provided they are arranged to rupture an opposing portion of the container.

Preferably, the rupturable container, at least when in a ruptured position, is in fluid communication with a fluid application region and/or fluid well, and therefore the second inlet. The fluid enters the capillary passage via the second inlet or third inlet, as defined above.

In an embodiment, fluid dispensing means are carried by the control element. In an embodiment, the control element preferably also defines a portion of a sample well or application region, for example as defined above. Preferably, the control element comprises a housing for a sealed container of fluid to be placed therein, and rupturing means. Preferably the housing is provided on the control element, as an integrated device. The housing may comprise a lid, preferably hinged to a wall of the housing, for insertion of and access to the fluid dispensing means and rupturing means.

In an alternative embodiment, fluid dispensing means may be provided separately to the control element or sample metering element, and can be integrated therewith. Preferably, where this is the case, it may be provided with the sample metering device as a kit of parts. If separate, it is preferably arranged to cooperate (be compatible with) with the sample metering device and/or the control element.

Alternatively, the fluid dispensing means may be composed of parts of the sample metering element and the control element. For example, rupturing means may be provided by the sample metering element (for example, as moulded upstanding projections), and the rupturable container and operating means may be provided by the control element.

In an embodiment, a single control element may be provided comprising sealing means (e.g. constituted by a sealing component), carrying means for a rupturable, sealed container of fluid (and optionally the container of fluid) and/or rupturing means and optionally operating means for bringing into contact a rupturable, sealed container and rupturing means. Such a control element preferably also defines a lid of a sample well or sample application region, by opening or closing the well or application region when moved between two positions.

In such an embodiment, movement of the control element to operate the sealing means may be combined with movement to open or close a sample well or application region, and/or movement to rupture the container. Thus, for example, movement of the control element to operate sealing means may also open or close the sample well or application region and/or cause the container to be brought into contact with rupturing means. For example, in a preferred embodiment, a rotational movement of the control element may serve to open the sample well and seal the outlet of the capillary passage. A further rotational movement may operate the sealing means drive operating means such that the container is brought into contact with rupturing means. In such an embodiment, a cam may be provided to operably link the rotational movement of the control element with a linear movement of the operating means.

Alternatively, movement of the control element to operate sealing means may be independent of opening and closing of the sample well and/or from the operating means to bring the container into contact with the rupturing means. Thus, separate actions are required.

Preferably, the control element is a control element comprising sealing means, as described herein.

The container is preferably movable relative to the rupturing means, although other arrangements are possible, such as the rupturing means being movable relative to the container, or both being movable to come into contact.

In one preferred arrangement, the container is arranged for downwards movement, to be brought into contact with rupturing means. In this embodiment, the rupturing means are preferably provided on the control element. The rupturing means may comprise projections, which the container is impaled onto. In another preferred embodiment, the container is arranged for impaling on projections and being pierced by spikes. In a preferred embodiment, the operating means comprise a plunger. The plunger may be initially retained in the first position, separated from the rupturing means by a spacer, e.g. by rupturable webs. On removal of the spacer, for example, rupturing of the webs, the plunger is freed and can be moved to the second position in which the container is brought into contact with the rupturing means, and the contents are released. Preferably, the container is carried by the plunger. Preferably, the plunger is carried, or is part of, a control element. Preferably, the rupturing means are carried by the device, or a control element, or a distinct element. Instead of rupturable webs, a removable collar may be provided to prevent premature operation of the plunger. In a preferred embodiment, the removable collar includes a cap to cover the sample application region.

In an alternative embodiment, it is the rupturing means rather than the container which moves. Rupturing means may be provided adjacent to the fluid dispensing means, and are operated to move downward and rupture the dispensing means. The rupturing means may be provided on an inner side wall of the housing. In this embodiment it is preferable that the rupturing means are moved between a first, ready position and a second rupturing position by rotational movement of the control element.

Preferably, the container or rupturing means are movable within the control element between the first and second positions, e.g. either being carried by or constituting a plunger operable from the exterior of the control element by simple application of force, e.g. manually by a user or in automated manner. The relative movement between the rupturing means and the container may be axial or linear (i.e. the movement of the operating means may be linear or axial). Activation brings the rupturing means and container into contact, thus releasing fluid from the container. Preferably, the same action brings second rupturing means into contact with the container, to allow air to pass into the container. Thus, preferably, fluid passes passively from the container.

In a preferred embodiment, the operating means comprise a mechanism such that the container is brought into contact with rupturing means. In a preferred embodiment, a cam may be provided to operably link the rotational movement of the control element with a linear movement of the operating means. Thus, the container and/or rupturing means are moved relative to each other in a linear path upon rotational movement of the control element.

The fluid dispensing means is conveniently used to dispense fluid to a capillary passage preferably via the second or a third inlet.

This embodiment of the device of the invention is conveniently used in such sample metering devices for supplying a known volume of reagent, e.g. a chase buffer, to the system. This enables the assay to be carried out using a smaller quantity of sample than would otherwise be required.

The invention can enable fluid to be dispensed reliably in known quantities, determined by the container contents, even small volumes such as 1000 microlitres or less, 500 microlitres or even less.

A device of the invention can thus be easy to operate, to deliver a predetermined volume of fluid, and can be used reliably by relatively unskilled personnel.

A control element as discussed above can be easily manipulated by a user, and can be used reliably by relatively unskilled personnel to deliver accurately controlled quantities of liquids.

Optionally, a timer is associated with a device of the invention. The timer may be used to indicate the time for moving the sealing means or a control element between positions, and/or for rupturing the container. The timer is preferably provided on the control element.

Preferably, a capillary passage of the device, and optionally a side passage, may be treated to improve flow of liquid sample therethrough. Any suitable method may be used, for example, dip tweening, or by passing treatment fluid through the passage to leave a surface coating on the internal surface of the passage. Thus, a capillary passage of the device and optionally a side passage comprise a coating on the inner surface thereof, of a treatment fluid.

The coating typically acts by minimising any repulsion between the inner surface of the passage and sample fluid, whilst preferably not actively binding or substantially reacting with any sample, fluid or component thereof. Preferably, the surface coating increases the hydrophilicity of the passage, as compared to an untreated passage. The coating may, for example, act by forming a layer on the inner surface of the treated passage, polymerising with the surface of the treated passage, or soaking into the material of the treated passage.

The treatment fluid may be a liquid or a gas, but typically is a liquid. Preferably, the treatment fluid, when passing through the passage, coats the inner surface of the passage (as discussed above, by leaving behind a layer of material, soaking into the passage material or polymerising therewith, for example). This coating has the effect of altering the surface properties of the passage, for example to improve fluid (e.g. sample) flow though the passage, for example by improving the hydrophilicity of the passage. Thus, the treatment fluid is preferably a liquid which improves flow of a liquid sample, and does not bind the sample. Preferably, it imparts hydrophilic properties.

Alternatively, the treatment fluid may be a reagent, for deposition in a passage. The treatment fluid may be a reagent, preferably an assay reagent, including for example reagents comprising agglutination reagents, antibodies, and labels. Other reagents include buffers, and any other assay components.

The thickness of the coating will depend upon the type of treatment fluid, the purpose of the coating, and the dimensions of the capillary passage. Where a layer of treatment fluid is left on the inner surface of the passage, it is preferably multi-molecular or mono-molecular layer. Preferably, the method of the invention causes substantially the entire inner surface of the treated passage to be coated with treatment fluid. Preferably, the inner surface comprises an open-topped channel formed within a component, and the cover member thereof.

Where it is desired to improve flow through a passage, this can be achieved by use of a treatment fluid with suitable hydrophilic properties, e.g. a surfactants. Suitable materials are well known to those skilled in the art, and include for example polysorbates, commonly being used for this purpose, particularly polyoxyethylene sorbitan materials known as Tween (Tween is a Trade Mark), e.g. Tween 20 (polyoxyethylene (20) sorbitan monolaurate), Tween 60 (polyoxyethylene (20) sorbitan monostearate), Tween 80 (polyoxyethylene (20) sorbitan monooleate). Such materials are typically used in the form of dilute aqueous solutions, e.g 0.1 to 10%, typically. 1% by volume or less, typically in deionised water, although other solvents such as isopropanol (IPA) may alternatively be used.

It is appreciated that any preferred features of embodiments of a device described herein may apply to another device described herein, and such embodiments are within the scope of the invention.

### DESCRIPTION OF THE DRAWINGS

A preferred embodiment of a sample testing device will now be described, by way of illustration, with reference to the accompanying drawings, in which:

FIG. 1 is a perspective view from above of a sample metering device comprising a sample metering element and control element;

FIG. 2 is a plan view of the underside of the element of FIG. 1;

FIG. 3 shows the view from above of a sample metering device;

FIG. 4 shows a side view of a sample metering device;

FIG. 5 is a perspective view from above of the device, showing the open housing of fluid dispensing means;

FIG. 6 shows a perspective view of the sample metering device, with the fluid dispensing means housing omitted for clarity;

FIG. 7 (a, b and c) show the components of the control element;

FIG. 8 shows the underside of a sample metering element in an alternative embodiment;

FIG. 9 shows a plan view of the upper surface of the device of FIG. 8;

### DETAILED DESCRIPTION OF THE DRAWINGS

The drawings illustrate a sample testing device having capillary passages or pathways for performing an agglutination assay, e.g. generally as disclosed in WO 2004/083859 and WO 2006/046054.

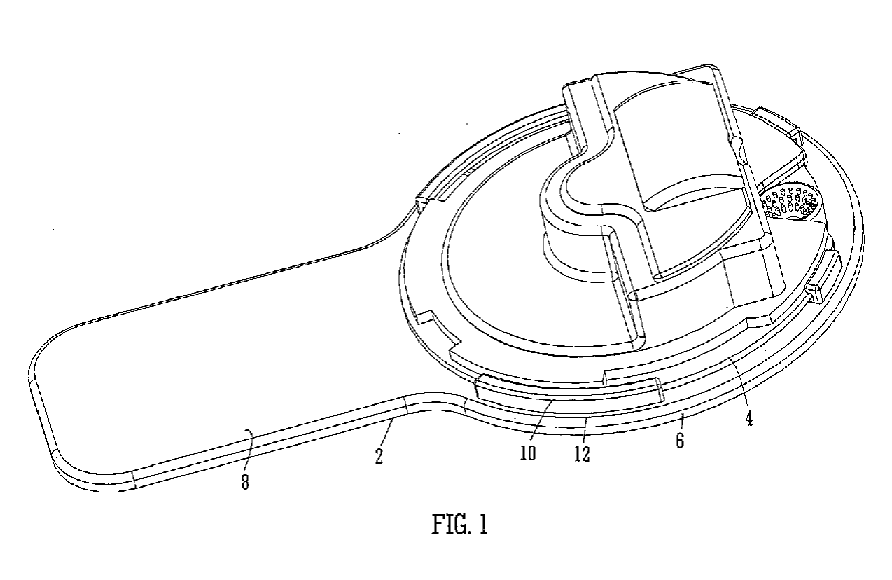

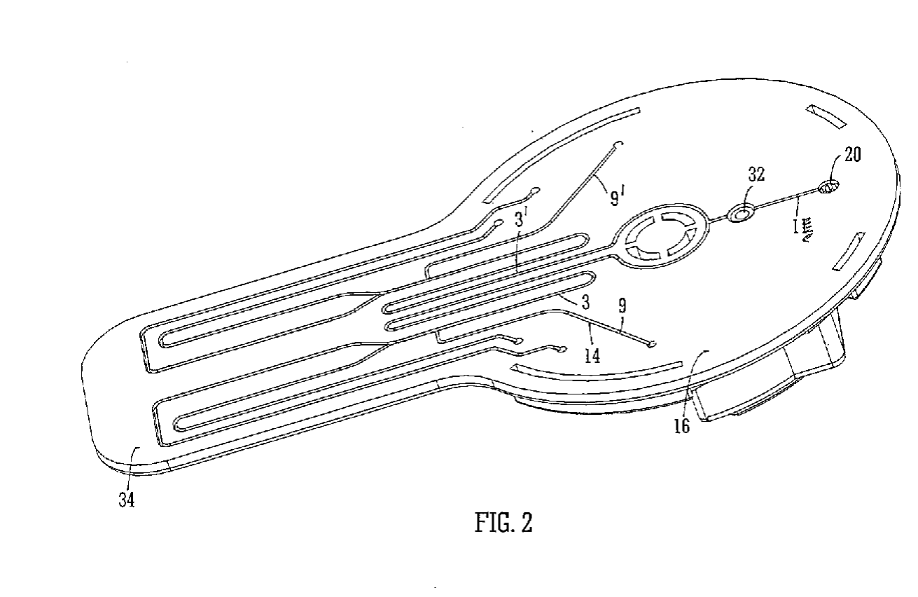

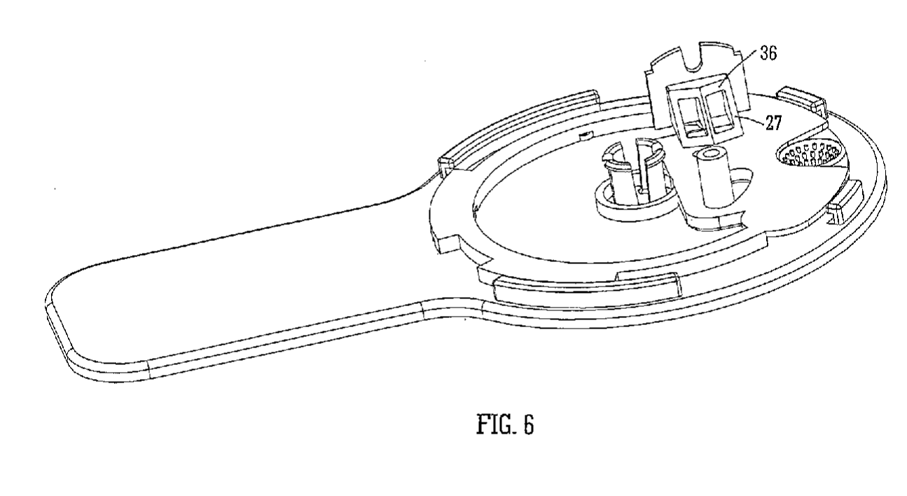

A device according to the invention, and suitable for blood testing, is shown in FIG. 1 comprises two main components: a sample metering element 2, and a control element 4. As shown in FIGS. 1 to 6, sample metering element 2 comprises a rigid, planar plate of injection moulded polycarbonate, having a circular head portion 6 and an elongate tail portion 8 extending therefrom. The sample metering element 2 is formed with an upstanding outer collar 10 on the upper surface 12 thereof, with a series of grooves constituting open-topped channels 14 formed in the lower surface 16 of the sample metering element 2.

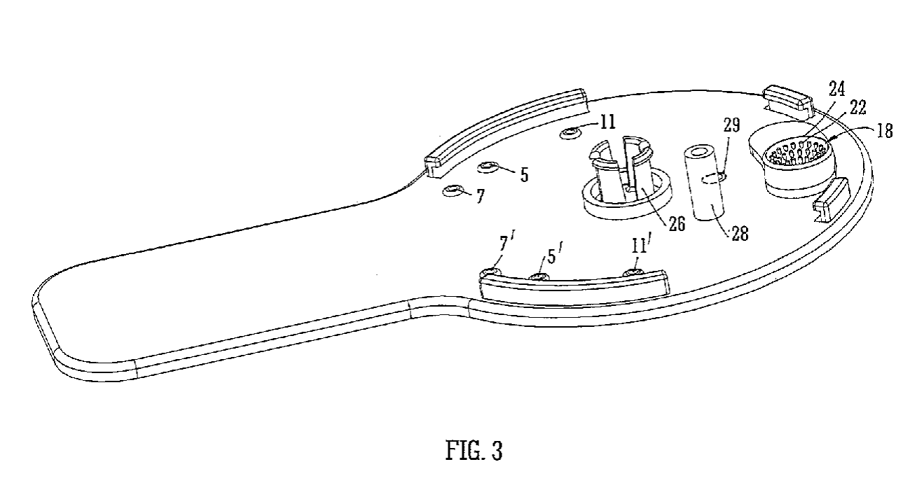

As seen best in FIG. 3, the outer collar 10 is located in the circular portion of the sample metering element 2 and includes part-circular portions constituting part of a circle having a radius of about 32 mm. The outer collar 10 works in conjunction with the inner collar 26 and is provided to retain in place a control element 4 on the upper surface 12 of the sample metering element 2.

The upper surface of the sample metering element 2 includes a circular, funnel-like, recessed portion (well) 18, leading to a first inlet 20 extending through the sample metering element 2 to the grooves 14 on the lower surface 16 of the sample metering element 2. The funnel-like recessed portion 18 comprises micropillars 22 extending downward from the inside surface 24 of the recessed portion 18 toward the lower surface 16 of the sample metering element 2. The micropillars 22 help to draw the sample into the sample application region and also aid the flow of the sample toward the grooves in the lower surface 16 of the sample metering element 2. The upper surface 12 of the sample metering element 2 further comprises an upstanding inner collar 26 formed of four part-circular sections, which form both a retaining feature and a pivot point about which the control element 4 turns, when placed upon the sample metering element 2. The pivot point is located centrally within the circular portion 6 of the element 2. The upper surface 12 of the sample metering element 2 further comprises an upstanding post 28 which serves to hold buffer release capsule 30 in place during puncturing. Through hole 29 is provided in upper surface 12 for fluid to flow from buffer release capsule 30 into second inlet 32 on the lower surface of the element.

A single passage 1 extends from the first inlet 20 on the lower surface 16 of the sample metering element 2 to the second inlet 32. From the second inlet 32, a further single passage extends, which then branches into two passages 3, 3′ which define two similar side-by-side capillary passages, arranged as mirror images, constituting a test passage 3 and a control passage 3′. Each passage comprises a main passage 3, 3′ arranged in a serpentine configuration. These passages 3, 3′ extend from the second inlet 32 to respective outlets 5, 5′ 7, 7′ that pass through the sample metering element 2 and open on the upper surface 12. Each passage includes an overflow (side) passage 9, 9′ extending as a side branch perpendicular from the associated main passage 3, 3′ and turning through 90° to extend firstly back towards the first and second inlets 20, 32, and then turning through 45° to extend in a direction toward the outer edge of the sample metering element 2.

Each overflow passage 9, 9′, terminates in respective overflow passage outlets 11, 11′ which is open on the upper surface 12 of sample metering element 2. The side (overflow) passages 9, 9′ are wider than the main passages. The main passages 3,3′ then each branch into two passages, which extend in parallel toward the bottom end 34 of the elongate section 34 of the sample metering element 2, turning then through 90° to extend along the bottom end 34, then turning again through 90° to extend back toward the first and second inlets 20,32. Within the circular section, the passages each turn through 45° to extend toward the outer edge of the circular section, and each ends in respective main passage outlets, 5, 5, 7,7′ that pass through the sample metering element 2 and open on the supper surface 12.

The main passages 3, 3′ are V-shaped in section and have the cross-sectional profile of an equilateral triangle with sides 0.435 mm long. The depth of these passages is 0.377 mm. The overall length of each main channel is approximately 200 mm. The overflow passage 9, 9′ are trapezoidal in cross section, having a flat base 0.3 mm in length with outwardly inclined side walls defining an angle of 60° therebetween. The depth of these passages is 0.38 mm. The overall length of each overflow passage 9, 9′ is approximately 38 mm.

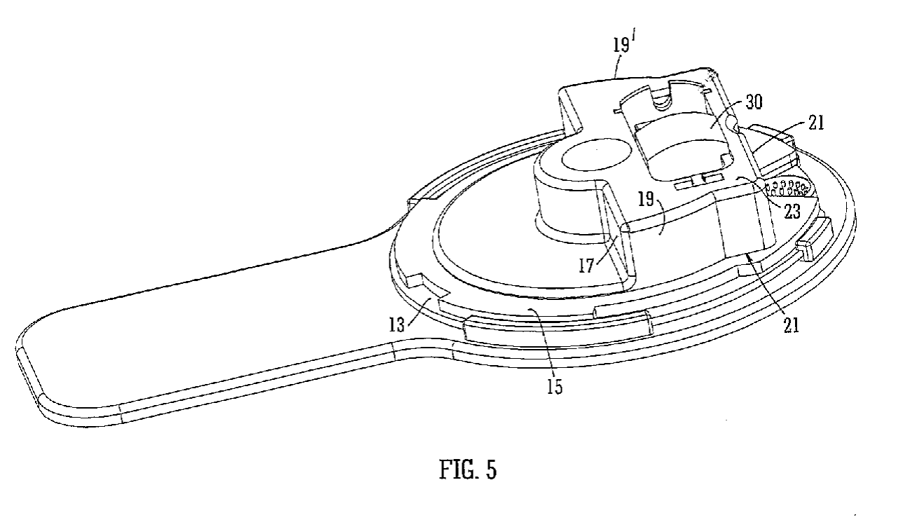

As shown in FIG. 1, the control element 4 can be fitted to the sample metering element 2. As shown in FIG. 5, the control element 4 comprises a generally circular planar, rigid first portion 13 of injection-moulded acrylonitrile butadiene styrene (ABS) with a diameter of about 63 m and a height of about 1.2 mm. The height refers to the thin flange of circular portion 13. Overall the height of the control element from the base to the top is approximately 13.5 mm. The circular first portion 13 comprises sealing means (not shown) on the underside, which is in contact with the upper surface 12 of the element 2. The generally circular first portion 13 also comprises cut out sections to reveal or shield (or seal) the funnel-like sample entry port 18, such that in a third or fourth and fifth positions as defined above when sample has entered the channels, access to the funnel-like sample entry port is closed to the user. The opening or closing of the sample entry port 18 is actioned by rotating the control element about the pivot 26 provided on the sample metering element 2.

The circular planar first portion 13 is stepped to second portion 15 which comprises a semi-circular portion of smaller diameter than the first portion 13. A first upstanding wall 17 extends along the straight edge of the semi-circular portion, and defines an inner semi-circle centrally on the straight edge, thus defining a planar “C” shape. The inner semi-circular wall 17 defines a recess about the pivot point which upstands from the upper surface 12 of the element 2. Side walls 19, 19′ extend to follow the circumferential edge from the ends of first wall 17, and an end wall 21 is provided to define with the first wall 17 and side walls 19, 19′, a generally rectangular housing 21 which houses buffer release means. A lid 23 is provided to close the buffer release means housing.

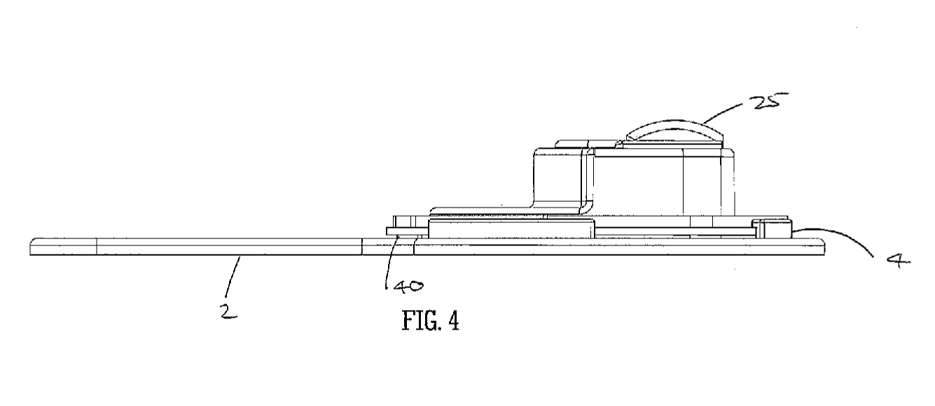

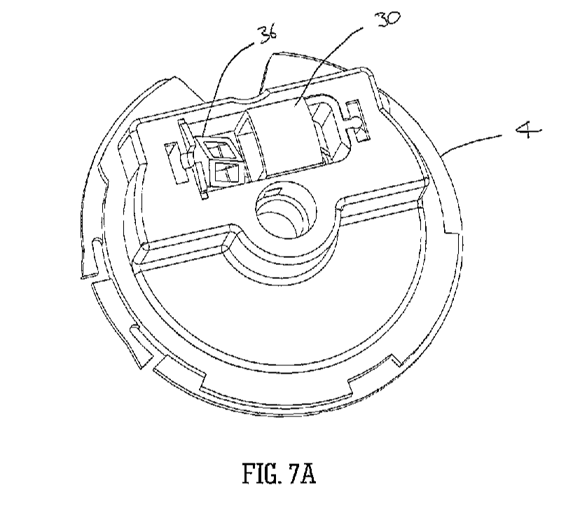

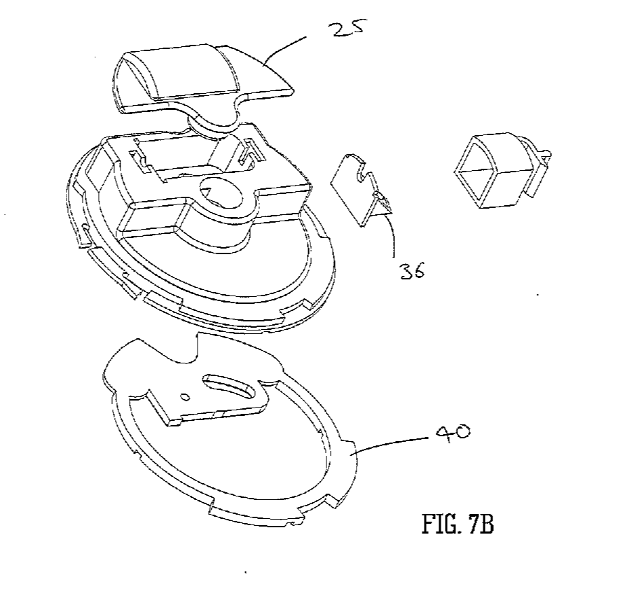

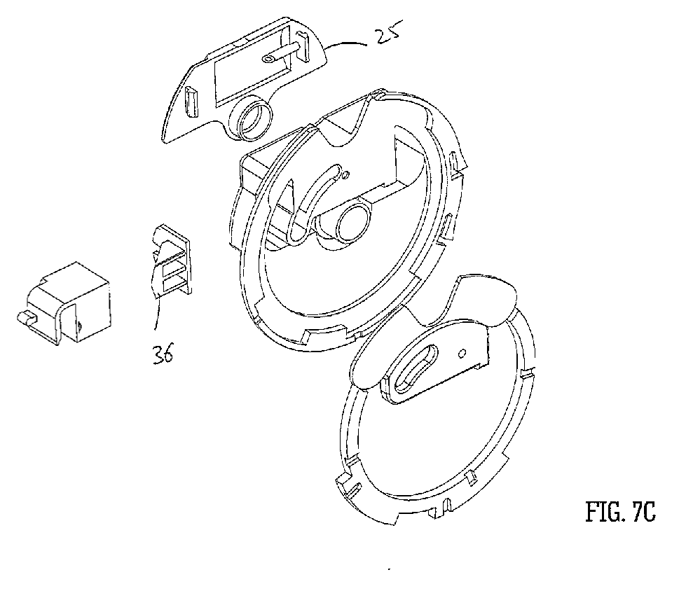

The substantially rectangular housing 21 comprises an arcuate cover 25 (FIG. 4). Within the housing is provided a buffer release capsule 30 which is held in placed by post 28. As shown in FIG. 7b, rupturing (or piercing) means 36 are provided on a planar element 31 which sits against an inner surface 33 of side wall 19′. A cam is provided (not shown) such that rotation of the control element causes the puncturing means 36 on planar element 31 to move toward capsule 36 and drive into it. The rupturing means 36 comprise a series of fins 27 which extend outwardly, and which are joined together at a centrally defined point which in an active position can intersect the fluid filed polypropylene capsule 30 which is dimensioned to fit snugly within the housing 21. Thus, the rupturing means 36 are movable between a first, ready position, and a second activated position by application of a suitable rotational force to the rupturing element. The force causes the capsule 30 to be punctured with consequential release of the fluid contents into the fluid application region 29.

The lower surface of the control element 4 includes groove 38. A cylindrical soft rubber seal 40 of thermoplastic elastomer (TPE) with a Shore hardness of 40A is fitted into the grooves standing slightly proud of the lower surface of the control element 4, forming sealing members that cooperate with the capillary passage outlets 5, 5′, 7, 7′ and 11, 11′, as will be described below.

A sheet of flexible foil 106 in the form of a clear polycarbonate sheet 0.06 mm thick is secured by laser welding to the lower surface 16 of the sample metering element 2 to cover the passages 3, 3′, 9, 9′ and convert them into enclosed capillary passages, also referred to herein as capillary pathways.

Hydrocarbonates such as ABS or polycarbonates are hydrophobic which means that aqueous fluids will not flow well within the passages. To address this, the capillary passage internal surfaces are treated to provide a thin coating of Tween 20 surfactant (Tween is a Trade Mark) to impart hydrophilic properties to the capillary surface. This can be done by any suitable means, for example using a vacuum process to draw a solution of Tween 20 in deionised water (comprising 0.5% by volume Tween 20) through the capillary passages, by applying suction at an open end of the passages or by dip tweening.

This treatment also performs a quality control function in that it will reveal if any of the capillary passages are blocked, e.g. as a result of imperfect moulding, imperfect sealing of the foil, or the presence of debris or foreign matter in the passages, enabling defective elements to be discarded at this stage.

The device is prepared for use in agglutination assay by depositing a controlled amount of agglutination reagent, e.g. as disclosed in WO2004/083859 and WO 2006/046054, in the test passage 3. Any suitable method can be used for depositing the reagent. A preferred method is by depositing reagents on a plug, which is inserted into a capillary track during manufacture. Alternatively, reagents may be deposited by dispensing a fluid containing the reagents directly into the capillary track and drying them in situ as required prior to applying the covering seal. A preferred method is by depositing reagents in a plug, which is inserted into a capillary passage during manufacture. Control element 4 is then located on the outer collar 10 of sample metering element 2, with the control element 4 in a first position, where the device is in an inactive state. In the first position, the control element 4 is positioned such that the sample entry well 18 is shielded/sealed by the planar circular portion 13 of the control element 4, so cannot be used and is also protected from ingress of foreign material. None of the passage outlets 5, 5′, 7, 7′, 11, 11′ are sealed.

The device in this condition may be packaged for distribution and sale, e.g. being sealed in a foil pouch which is impermeable to air and moisture.

When the device is required for use, the control element 4 is rotated to a second position. In this position, the planar circular portion 13 is positioned such that the sample entry well 18 is exposed, and sample can enter the sample entry hole 20 of the element. In addition, the main passage outlets 5, 5′, 7, 7′ are sealed by portions of the seal 40, while the overflow passage outlets 11, 11′ are not sealed.

A quantity of fluid sample e.g. a blood sample to be tested (possibly containing an analyte of interest) is added to the device via sample entry hole 20. It is important that more sample is added than is required for the test, with a sample of about 15 microlitres being appropriate in the present case. The sample fluid flows along the initial portions of the main passages 3, 3′ and then into the overflow passages 9, 9′. The sample cannot flow further along the main passages 3, 3′ because the main channel outlets 5, 5′, 7, 7′ are sealed by the seal 40 of the control element 4. In this way, a defined quantity of sample is present in each of the main passages (referred to as the test volume), with excess being passing into the overflow passages. In the present embodiment, the test volume in each main passage is about 5 microlitres.

The control element 4 is then rotated through a third position (where the sample well 18 of the sample metering element 2 is shielded (sealed) by the planar circular portion 13 of the control element 4, the overflow channel outlets, 11, 11′ and the main channel outlets 5,5′, 7, 7′ are now sealed by seal 40, respectively to a fifth position where the sample well 18 remains sealed, the overflow channel outlets 11, 11′ remain sealed by seal 40, whilst the main passage outlets 5, 5′, 7, 7′ are not sealed.

Fluid in the capsule is then introduced to the capillary passages 3, 3′. Typically the fluid is a chase buffer, e.g. a 1% by weight solution of Ficoll polymer in deionised or distilled water (Ficoll is a Trade Mark), which enables the reaction to be carried out with a smaller volume of sample than is required to flow around the entire capillary system to determine a test result. This is achieved by operation of the rupturing means 36.

Rotation of control element and 4 causes movement of rupturing means 36 into the activated position, resulting in piercing of the capsule by the point 36, and release of fluid from the capsule to flow into the second inlet 32. In the preferred embodiment shown, this is achieved by rotation of the cap 4 between positions 2 and 4 which causes the rupturing means 36 to move relative to the capsule 30 which is retained by post 28.

The capsule fluid e.g. chase buffer pushes the test sample further along the main passages, 3, 3′.

Sample (followed by chase buffer) will flow along the main passages, by capillary flow. Because the overflow passage outlets 11, 11′,' are now sealed, no further flow will take place along the overflow passages 9, 9′, including no back-flow towards the main passages. Instead, fluid flow will be along the main passages, 3, 3′, towards the unsealed main passage outlets 5, 5′, 7, 7′. The sample will thus flow past the deposited reagent in the test passage 3. If the analyte of interest is present in the sample, this will react with the reagent, affecting the flow properties.

The device includes a detector arrangement (not shown) near the ends of the main passages to detect the presence (or otherwise) of liquid in the test passage 3 and control passage 3′. From this, it can be determined whether reaction has taken place with the agglutination reagent, and information (qualitative or quantitative) can be determined about the presence of the analyte of interest in the test sample. Suitable detector arrangements are known, and are outside the scope of this invention.

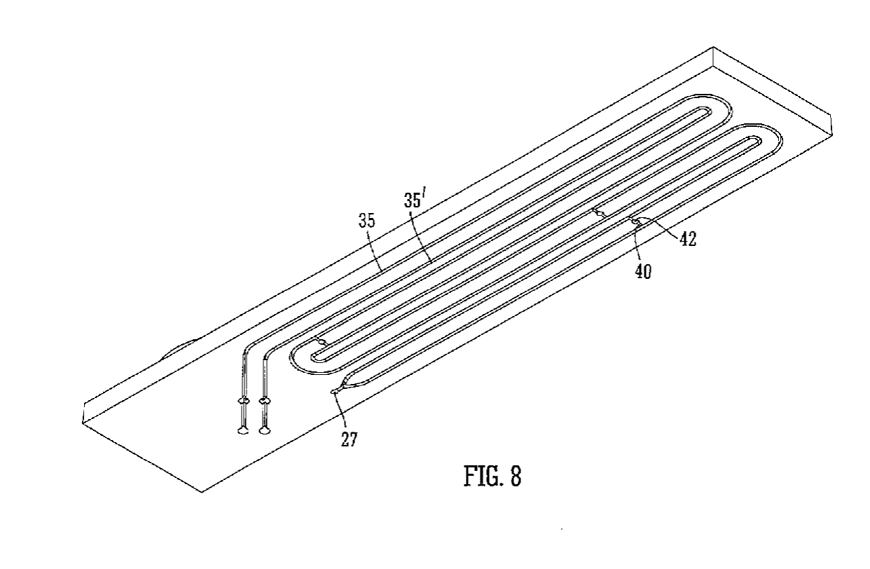

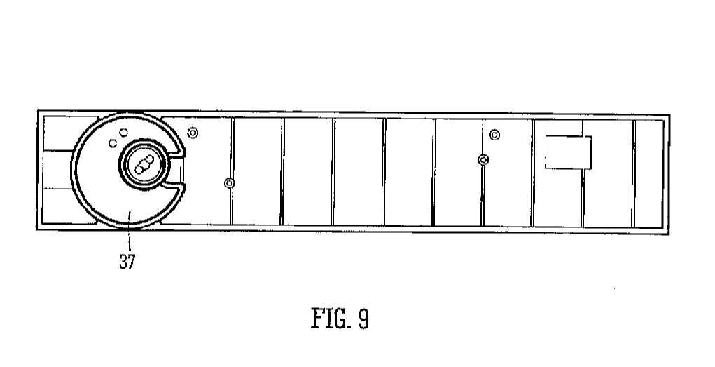

FIGS. 8 and 9 show an alternative embodiment of the invention suitable for quantitative or semi-quantitative agglutination assays. Test passage 35 comprises analyte-specific reagents which have been deposited; control passage 35′ is empty of reagents, or comprises only control reagent, which will not cause a reaction in the presence of analyte. As shown in FIG. 9, sample is added to large well 37 (FIG. 9) and flows into both passages 35 and 35′, whilst chase buffer is added to the small central well 39 and enters the capillary 35, 35′ downstream of the sample well 37. If the analyte of interest is present in the sample this will react with the reagent, affecting the flow properties in the test passage 35 compared with unreacted sample in the control passage 35′.

The device includes a detector arrangement (not shown) near the ends of the main passages 3, 3′, 35, 35′ to detect the presence (or otherwise) of liquid. From this, it can be determined whether reaction has taken place with the agglutination reagent, and information (qualitative or quantitative) can be determined about the presence of the analyte of interest in the test sample. Suitable detector arrangements are known, and are outside the scope of this invention. In the blood group test shown in FIGS. 1-7, the 4 passages contain reagents specific for the major blood groups (A, B, O and Rhesus D). For a sample of a given blood group, it will react with appropriate specific reagent and flow in that passage will be retarded compared with the other channels (where no reaction occurs). In the embodiment shown in FIGS. 8 and 9, the flow in the test passage 35 will be slowed in a dose-dependent manner compared with the control passage, and by comparing the flow rates in the two passages the amount of analyte in the sample can be determined using a dose-response curve derived using calibrators of known concentration.

The device is easy to use, and can be used reliably by relatively unskilled personnel, possibly at the point of care of patients. In particular, the device functions to provide a predetermined volume of sample into the capillary test system, by the operation of the overflow passages 9, 9′, and a predetermined volume of reagent such as chase buffer from the capsule. The device requires only a very small volume of sample to be tested, e.g. about 10 to 15 microlitres. The device is intended for single use, being disposed of after use.

1. A sample metering device for a liquid sample, the device comprising a sample metering element comprising: i) at least one capillary passage with a first inlet, a second inlet, and a first capillary passage outlet; ii) a side passage extending from the capillary passage part way along the length thereof and leading to a side passage outlet; and a control element comprising: i) first sealing means operable releasably to seal the capillary passage outlet; and ii) second sealing means operable releasably to seal the side passage outlet.

2. The sample metering device according to claim. 1, wherein a member selected from the sample metering element and control element comprises: i) a first fluid (sample) application region for receiving a liquid sample to be tested, for entry to the capillary passage via the first inlet; and optionally a second fluid application region for receiving a fluid, for entry to the capillary passage via the second inlet.

3. A sample metering device according to claim 1, wherein the second inlet is located between the first inlet and the intersection with the side passage.

4. The sample metering device according to claim 1, wherein the second inlet is located immediately downstream of the first inlet to maximise the test volume within at least 15 mm of the first inlet.

5. The sample metering device according to claim 1, wherein the sealing means are located on the underside of the control element and are not in contact with liquid in a capillary passage.

6. The sample metering device according to claim 1, wherein the sample metering element comprises more than one capillary passage, each with an associated side passage.

7. The sample metering device according to claim 1, further comprising a third inlet downstream of the second inlet, for addition of reagent to the capillary passage.

8. The sample metering device according to claim 6, wherein the capillary passages have a common first inlet and/or a common second inlet and/or a third common inlet.

9. (canceled)

10. The sample metering device according to claim 1, Wherein the side passage has a larger cross-sectional area than the capillary passage.

11. The sample metering device according to claim 1, wherein the sample application region and fluid application region are independently each in fluid communication with a well.

12. (canceled)

13. The sample metering device according to claim 11, wherein the base of the well comprises the sample or fluid application region.

14. (canceled)

15. (canceled)

16. The sample metering device according to claim 1, wherein the capillary passage comprises a second outlet, removed from a distal or proximal end of the capillary passage, and first sealing means operable to releasably seal the second outlet, to control flow of the liquid sample in the device.

17. (canceled)

18. (canceled)

19. (canceled)

20. The sample metering device according to claim 2, wherein the control element includes a liquid inlet for passage of liquid to the fluid application region.

21. (canceled)

22. (canceled)

23. The sample metering device according to claim 1, wherein the control element is movable between:
i) a first, inactive position in which the first sealing means are positioned not to seal the capillary passage outlet(s) and the second sealing means are positioned not to seal the side passage outlet(s);
ii) a second metering position in which the first sealing means are positioned to seal the capillary passage outlet and the second sealing means are positioned not to seal the side passages outlet(s);
iii) an optional third holding position in Which the first sealing means are positioned to seal the capillary passage outlet(s), and the second sealing means are positioned to seal the side passage outlet(s); and
iv) a fourth position in which the second sealing means are positioned to seal the side passage outlet(s) and the first sealing means are positioned not to seal the capillary passage outlet(s).

24. The sample metering device according to claim 2, wherein the control element is movable with respect to the sample metering element between
i) a first, inactive position in which the sample application region or well is concealed to a user by the control element; a second liquid inlet is not in fluid communication with the fluid application region or well; the first sealing means are positioned not to seal the capillary passage outlet(s) and the second sealing means are positioned not to seal the side passage outlet(s);
ii) a second position in which the sample application region is exposed to a user and the first sealing means are positioned to seal the capillary passage outlet and the second sealing means are positioned not to seal the side passages outlet(s);
iii) an optional third holding position in which the first sealing means are positioned to seal the capillary passage outlet(s), and the second sealing means are positioned to seal the side passage outlet(s); and the sample application region and well is concealed;
iv) a fourth position in which the second inlet is in fluid communication with the fluid application region and/or well; and
v) a fifth position in which the second sealing means are positioned to seal the side passage outlet(s) and the first sealing means are positioned not to seal the capillary passage outlet(s).

25. The sample metering device according to claim 1, wherein the control element comprises two or more sealing means constituted by a single sealing component.

26. The sample metering device according to claim 1, wherein the control element comprises the first sealing means and the second sealing means constituted by a single sealing component, movable to bring the sealing component into sealing relationship with each of the outlets in turn.

27. The sample metering device according to claim 25, wherein the control element comprises respective first and second sealing components for each of the capillary passage outlet(s) and the side passage outlet(s), each of the first and second components being operable for sealing the associated outlet(s) or not.

28. (canceled)

29. The sample metering device according to claim 25 wherein two or more first sealing means are constituted by a single sealing component, moveable between a first position in which the first sealing means is positioned to seal the capillary passage outlet(s) and a second position in which the sealing means are positioned not to seal the capillary passage outlet(s).

30. The sample metering device according to claim 25, wherein two or more second sealing means are constituted by a single sealing component moveable between a first position in which the second sealing means are positioned to not seal the side passage outlet(s) and a second position in which the sealing means are positioned to seal the side passage outlet(s).

31. (canceled)

32. (canceled)

33. (canceled)

34. A sample metering device according to claim 1, comprising detection means for determining the presence of absence of liquid at a detection point in the capillary passage.

35. A sample metering device according to claim 1, wherein the sample metering element comprises a first capillary passage having a first inlet, a second inlet, and a capillary passage, and a second capillary passage having an inlet and which intersects the first capillary passage at a downstream point of convergence such that the first and second capillary passage have a common outlet.

36. A control element of the sample metering device of claim 1, said control element comprising: i) first sealing means operable releasably to seal the capillary passage outlet; and ii) second sealing means operable releasably to seal the side passage outlet.

37. A sample metering element of the sample metering device of claim 5, said sample metering element comprising: i) at least one capillary passage with a first inlet, a second inlet, and a capillary passage outlet; and ii) a side passage extending from the capillary passage part way along the length thereof and leading to a side passage outlet.

38. A kit or package comprising a control element selected from:
(1) a control element of a sample metering device, said control element comprising:
i) first sealing means operable releasably to seal the capillary passage outlet; and
ii) second sealing means operable releasably to seal the side passage outlet; and
(2) a sample metering element of a sample metering device, said sample metering element comprising;
i) at least one capillary passage with a first inlet, a second inlet, and a capillary passage outlet; and
ii) a side passage extending from the capillary passage part way along the length thereof and leading to a side passage outlet; and
(3) optionally one or more member selected from a calibration chart, buffers, capsules, reagents including agglutination regents, instructions for use, a reader, a timer, and a power supply.

39. A method of metering a liquid sample, comprising:
a) providing a sample metering device comprising:
(1) a sample metering element comprising:
(i) at least one capillary passage with a first inlet, a second inlet and a capillary passage outlet; and
(ii) a side passage extending from the capillary passage partway along the length thereof and leading to a side passage outlet;
(2) a control element comprising:
(i) first sealing means operable to releasably seal a capillary passage outlet; and
(ii) second sealing means operable to releasably seal a side passage outlet;
b) operating the device to reveal the sample application region or sample well, and operating the control element to position first sealing means to seal the capillary passage outlet(s) and to position second sealing means not to seal the side passage outlet(s);
c) applying liquid sample to a sample application region of the sample metering element;
d) optionally operating the control element to position first sealing means to seal the capillary passage outlet and to position second sealing means to seal the side passage outlet(s);
e) operating the device to seal the first inlet and/or sample application region; to hold liquid sample in the capillary passage and side passage without backflow to the sample application region or without excess sample entering the capillary passage;
operating the device to place the second inlet in fluid communication with a fluid application region or fluid well; and releasing fluid from a fluid well;
g) operating the control element to position first sealing means to not seal the capillary passage outlet(s) and to position second sealing means to seal the side passage outlet(s); and
h) optionally applying reagent to a capillary passage via a third inlet.

40. (canceled)
